(19) United States
(12) Patent Application Publication
(10) Pub. No.: US 2006/0016687 A1
(43) Pub. Date: Jan. 26, 2006

(54) Methods of making a ceramic device and a sensor element

(76) Inventors: David P. Wallace, Flint, MI (US); Wayne M. Chadwick, Grand Blanc, MI (US); Walter T. Symons, Grand Blanc, MI (US)

Correspondence Address: Jimmy L. Funke;Mail Code: 480-410-202, P.O. Box 5052, Troy, MI, 48007, US

(21) Appl. No.: 10/896,349

(22) Filed: Jul. 21, 2004

(51) Int. Cl. G01N 27/26

(52) U.S. Cl. 204/515; 204/424

(57) ABSTRACT

A method of making a sensor element comprises forming a sensor element comprising a first electrode and a second electrode disposed in physical communication with an electrolyte; and applying an electric field of negative potential to a surface of the sensor element sufficient to draw positively charged impurities to the surface of the sensing element.

### BACKGROUND

Sensors, in particular gas sensors, have been utilized for many years in several industries (e.g., in furnaces and other enclosures, in exhaust streams such as flues, exhaust conduits, and the like, and in other areas). For example, the automotive industry has used exhaust gas sensors in automotive vehicles to sense the composition of exhaust gases, for example, oxygen. A gas sensor can be used to determine the exhaust gas content for alteration and optimization of the air to fuel ratio for combustion.

One type of sensor comprises a sensor element comprising an ionically conductive solid electrolyte between porous electrodes. For oxygen sensing, solid electrolyte sensors are used to measure oxygen activity differences between an unknown gas sample and a known gas sample. In the use of a sensor for automotive exhaust, the unknown gas is exhaust and the known gas, i.e., reference gas, is usually atmospheric air because the oxygen content in air is relatively constant and readily accessible. This type of sensor is based on an electrochemical galvanic cell operating in a potentiometric mode to detect the relative amounts of oxygen present in an exhaust from an automobile engine. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle includes an ionically conductive solid electrolyte material, a porous electrode with a porous protective overcoat exposed to exhaust gases (“exhaust gas electrode”), and a porous electrode exposed to a known gas partial pressure (“reference electrode”). Sensors used in automotive applications can use a yttrium stabilized zirconia based electrochemical galvanic cell with porous platinum electrodes, operating in potentiometric mode, to detect the relative amounts of a particular gas, such as oxygen for example, that is present in an exhaust from an automobile engine. Also, a sensor element can have a heater to help maintain the ionic conductivity of the sensor element. When opposite surfaces of the galvanic cell are exposed to different oxygen partial pressures, an electromotive force is developed between the electrodes on the opposite surfaces of the zirconia wall, according to the Nernst equation:

$$E = ( \frac{RT}{4 F} ) ln ( \frac{{P}_{{O}_{2}}^{ref}}{{P}_{{O}_{2}}} )$$

where:

E=electromotive force

R=universal gas constant

F=Faraday constant

T=absolute temperature of the gas

P_{O}^{₂}^{ref}=oxygen partial pressure of the reference gas

P_{O}^{₂}=oxygen partial pressure of the exhaust gas

Due to the large difference in oxygen partial pressure between fuel rich and fuel lean exhaust conditions, the electromotive force (emf) changes sharply at the stoichiometric point, giving rise to the characteristic switching behavior of these sensors. Consequently, these potentiometric oxygen sensors indicate qualitatively whether the engine is operating fuel-rich or fuel-lean, conditions without quantifying the actual air-to-fuel ratio of the exhaust mixture. Oxygen sensors measure the oxygen present in the exhaust to make the correct determination when the oxygen content (air) exactly equals the hydrocarbon content (fuel).

As noted above, the sensor element of the sensor can comprise a heater that can be used to elevate the temperature of the sensor to provide ample conditions for the sensor to operate. However, the heater can collect sodium ions that can be present in the support/substrate material of a sensor element. This collection of sodium ions can cause the sensor element to delaminate or cause a break in the heater circuit. Furthermore, the collection of sodium can also change the heater resistance and thermal dissipation characteristic of the heater.

What is needed in the art is a method of making a sensor element, ceramic heater, and the like, that reduces and/or eliminates the concentration of sodium ions that collect on the heater of the sensor element, the heater element of the ceramic heater, and the like.

### SUMMARY

Disclosed herein are methods of making ceramic devices and sensor elements.

One embodiment of a method of making a sensor element comprises forming a sensor element comprising a first electrode and a second electrode disposed in physical communication with an electrolyte; and applying an electric field of negative potential to a surface of the sensor element sufficient to draw positively charged impurities to the surface of the sensing element.

One embodiment of a method of making a ceramic device comprises forming a ceramic device by disposing a resistive element on a ceramic substrate; and applying an electric field of negative potential to a surface of the ceramic device sufficient to draw positively charged impurities to the surface of the ceramic device.

The above described and other features are exemplified by the following figures and detailed description.

### DRAWINGS

Refer now to the figures, which are exemplary embodiments, and wherein the like elements are numbered alike.

FIG. 1 is an exploded view an exemplary embodiment of a planar gas sensor element.

FIG. 2 is a schematic illustration of an electrical configuration employed to draw ions to a surface of a gas sensor element.

### DETAILED DESCRIPTION

Disclosed herein are method(s) of reducing the sodium concentration of ceramic devices (e.g., sensors). Although described in connection with an oxygen sensor, it is to be understood that the sensor could be a nitrogen oxide sensor, hydrogen sensor, hydrocarbon sensor, temperature sensor (e.g., a resistance temperature detector (RTD)), particulate sensor, or the like. Furthermore, while oxygen is the reference gas used in the description disclosed herein, it should be understood that other gases could be employed as a reference gas. Furthermore, it is also understood that various sensor geometries are also feasible (e.g., planar and conical), as well as multiple cell sensors. Additionally, other examples of ceramic devices capable of employing the described sodium concentration reduction method, include low/high temperature co-fired ceramic circuit applications (LTCC and HTCC, respectively), ceramic heaters, and the like.

The term “resistive element” is use to generically describe any conductive material disposed in/on a ceramic substrate. It should further be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.).

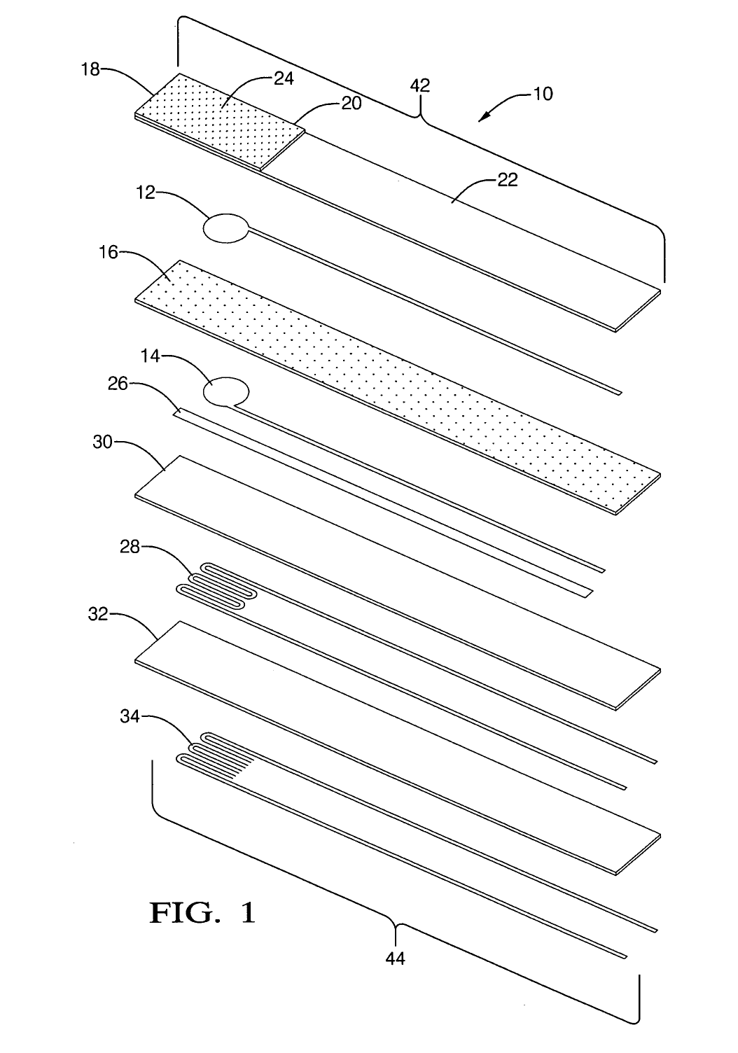

Furthermore, it is noted that various sensor elements can have similar structural elements to each other. As such, an exemplary sensor element is shown in FIG. 1 to illustrate the common elements of a sensor element. However, distinct features of each embodiment will be discussed in greater detail when such embodiments are first introduced.

Referring to FIG. 1, an embodiment of a planar gas sensor element 10 is illustrated. The sensing (i.e., first, exhaust gas, or outer) electrode 12 and the reference gas (i.e., second or inner) electrode 14 are disposed on opposite sides of, and adjacent to, an electrolyte layer 16 creating an electrochemical cell (12/16/14). It is noted, however, that some sensors employ both electrodes 10/12 on the same side of the electrolyte layer 16. On a side of the sensing electrode 12, opposite electrolyte 16, can be an optional protective layer (substrate) 18 that enables fluid communication between the sensing electrode 12 and the exhaust gas. This protective layer 18 can optionally comprise a porous portion 20 disposed adjacent to the sensing electrode 12 and a solid portion 22. Disposed over at least a portion of the protective layer 18, adjacent the sensing electrode 12 can be a protective coating 24.

Meanwhile, disposed on a side of the electrolyte 16, opposite sensing electrode 12, can be an optional reference gas channel 26, which is in fluid communication with the reference electrode 14 and optionally with the ambient atmosphere and/or the exhaust gas. Disposed on a side of the reference gas channel 26, opposite the reference electrode 14 can optionally be a heater 28 for maintaining sensor element 10 at a desired operating temperature. Disposed between the reference gas channel 26 and the heater 28, as well as on a side of the heater opposite the reference gas channel 26, can be one or more insulating layers 30, 32.

The electrolyte 16, which can be a solid electrolyte, can be formed of a material that is capable of permitting the electrochemical transfer of oxygen ions while inhibiting the passage of exhaust gases. Possible electrolyte materials include zirconium oxide (zirconia), cerium oxide (ceria), calcium oxide, yttrium oxide (yttria), lanthanum oxide, magnesium oxide, and the like, as well as combinations comprising at least one of the foregoing electrolyte materials, such as yttria doped zirconia, and the like.

Disposed adjacent to electrolyte 16 are electrodes 12, 14. The sensing electrode 12, which is exposed to the exhaust gas during operation, preferably has a porosity sufficient to permit diffusion of oxygen molecules therethrough. Similarly, the reference electrode 14, which can be exposed to a reference gas such as oxygen, air, or the like, during operation, preferably has a porosity sufficient to permit diffusion of oxygen molecules therethrough. These electrodes can comprise a metal capable of ionizing oxygen, including, but not limited to, platinum, palladium, gold, osmium, rhodium, iridium, ruthenium and the like as well as combinations comprising at least one of the foregoing metals. Other additives such as metal oxides, such as zirconia, yttria, ceria, calcium oxide, aluminum oxide (alumina), and the like, can be added to impart beneficial properties such as inhibiting sintering of the platinum to maintain porosity.

Protective layer 18 disposed on the side of the sensing electrode 12, opposite electrolyte 16, is designed to allow the electrodes (12, 14) to sense the exhaust gas and provide structural integrity and protection to the sensing electrode 12 without inhibiting the performance of the sensor element 10. Possible materials for the protective layer 18, include spinel, alumina, (such as, delta alumina, gamma alumina, theta alumina, and the like, and combinations comprising at least one of the foregoing aluminas), as well as other dielectric materials.

Heater 28 can be employed to maintain the sensor element 10 at the desired operating temperature. More particularly, heater 28 can be a heater capable of maintaining an end of the sensor element 10 that comprises the electrodes 12, 14 (i.e., the sensing end) at a sufficient temperature to facilitate the various electrochemical reactions therein. For an oxygen sensor, for example, an operating temperature of about 650° C. to about 800° C. can be employed, with an operating temperature of about 700° C. to about 750° C. preferred. Heater 28, which can comprise, for example, platinum, aluminum, palladium, and the like, as well as mixtures, oxides, and alloys comprising at least one of the foregoing metals, can be screen printed or otherwise disposed onto a substrate (e.g., insulating layers 30, 32), to a thickness sufficient to attain a desired resistance, e.g., for the heater 28 to be capable of bringing the sensor element 10 up to the desired operating temperature. For example, a thickness of about 5 micrometers to about 50 micrometers can be employed, with a thickness of about 10 micrometers to about 40 micrometers preferred.

Optional insulating layers 30, 32 provide structural integrity (e.g., protect various portions of the sensor element 10 from abrasion and/or vibration, and the like, and provide physical strength to the sensor element 10), and physically separate and electrically isolate various components. The insulating layer(s) can each be less than or equal to 200 micrometers thick, with a thickness of about 50 micrometers to about 200 micrometers preferred. The insulating layers 30, 32 can comprise a dielectric material such as alpha alumina, delta alumina, gamma alumina, theta alumina, and combinations comprising at least one of the foregoing aluminas, and the like. It is noted that the insulating layers 30, 32 can further comprise a sintering flux (e.g., sintering aid). Suitable sintering flux materials include, magnesium oxide (MgO), silicon dioxide (SiO₂), calcium carbonate (CaCO₃), and the like, as well as combinations comprising at least one of the foregoing.

In making the planar sensor element 10, the sensor element components, e.g., electrodes 12, 14, electrolyte 16, insulating layer(s) 30, 32, heater 28, protective layers 18, and the like, are formed using techniques such as tape casting methods, roll compaction, sputtering, punching and placing, spraying (e.g., electrostatically spraying, slurry spraying, plasma spraying, and the like), dipping, painting, and the like, as well as combinations comprising at least one of the foregoing techniques. For example, the electrolyte 16 can be formed and fired, with electrodes 12, 14 formed subsequently. Alternatively, the electrolyte 16 and one or both of the electrodes 12, 14 can be formed and co-fired.

For placement in a gas stream, sensor element 10 can be disposed within a protective casing (not shown) having holes, slits or apertures, generally to limit the overall exhaust gas flow contacting sensor element 10. This arrangement extends the useful life of sensor element 10 by minimizing the ion transport through the electrodes and electrolyte. Furthermore, any shape can be used for the sensor element 10, including conical, tubular, rectangular, and flat, and the like, and the various components, therefore, will have complementary shapes, such as circular, oval, quadrilateral, rectangular, or polygonal, among others.

In addition to the above described sensor components, other sensor components can be employed, including lead gettering layer(s), leads, contact pads, ground plane, ground plane layers(s), support layer(s), additional electrochemical cell(s), and the like. The leads, which supply current to the heater and electrodes, are often formed on the same layers as the heater or layers adjacent thereto and the electrodes to which they are in electrical communication and extend from the heater/electrode to a terminal end of the sensor element.

The ground plane (not shown), which can be disposed between two substrate layers (e.g., protective layer 18 and insulating layer 30), can comprise a metal, such as platinum, palladium, and the like; metal oxides such as alumina, and the like; as well as alloys and mixtures comprising at least one of these materials. The ground plane inhibits sodium induced heater failure by drawing sodium ions out of the substrate layers and retaining the sodium ions during operation. It is noted that sodium ions are generally present as a contaminant in alumina, which can be employed in the substrate layers. At the sensor element operating temperatures, and potential fields supplied by the voltage applied to the heater, sodium ions can become mobile in the alumina. Because sodium ions have a positive charge, they move toward a negative electrical potential, which is generally the heater ground in embodiments without a ground plane. In various embodiments, a ground plane can be employed to provide a harmless place to accumulate the sodium ions. However, the sodium ions remain in the sensor, which can still cause a number of issues. For example, sodium ions can cause cross talk (e.g., electrical communication) from the heater (e.g., 28) to an electrode (e.g., 14). Another issue that can result from sodium build-up is delamination of the sensor element and/or cracking of the sensor element. Therefore, it is preferable to reduce the sodium concentration in the sensor element.

It has been discovered that a positively charged impurity concentration, e.g., sodium ion concentration, in the sensor element can be reduced by applying an electrical field of negative potential (hereinafter “electrical field” for convenience in discussion) to the sensor element to draw positively charged impurities (e.g., sodium ions) to a surface(s) of the sensor element, i.e., toward the low potential (e.g., negative potential) side of the electrical field, such that the sodium ions can easily be removed from the sensor element. More particularly, the electrical field is preferably external to the sensor element. For example, an electrical field can be applied at a surface of the sensor element. However, it is noted that embodiments are envisioned and discussed below, wherein an electrical field can be applied within the sensor element (e.g., embodiments employing a ground plane). While the electrical field can be applied at anytime during manufacturing, it is preferably applied after assembling the sensor element for ease in manufacturing.

Further, the electrical field is of a sufficient magnitude to draw a sufficient concentration of sodium ions to the surface of the sensor element such that the sodium ions can be removed. It is noted that the amount of sodium ions drawn to the surface can vary depending on the initial concentration of sodium ions (e.g., concentration prior to removing sodium ions by the disclosed method) present in the sensor element. For example, in various embodiments, the sensor element can comprise an initial concentration of sodium ions of about 1,000 parts per million by weight (ppm) to about 5000 ppm sodium. It is envisioned that the sodium ion concentration after removing the ions can be less than or equal to 900 ppm, with less than or equal to 500 ppm preferred, and less than or equal to 200 ppm possible.

The magnitude of the electrical field can depend upon a number of variables, e.g., temperature of the sensor element, distance of the sensor element from a negative potential source that is used to generated the electrical field, the length of time the electrical field is applied to the sensor element, the desired final concentration of sodium ions in the sensor element, and the like. Preferably, these design variables are selected such that the resulting magnitude of the electrical field is a magnitude practical for production of the sensor element(s).

The electrical field can be applied to the sensor element at a temperature sufficient for the sodium ions to become mobile. In one embodiment, the electrical field can be applied during firing of the sensor element, since the mobility of the sodium ions increases at the elevated temperatures associated with firing. As such, all else being equal, a lower magnitude electrical field can be applied to the sensor element to cause at least the same amount of ion migration that can be caused with a higher magnitude electrical field when no heating is employed. For example, an electrical field can be applied at a temperature of about 600° C. to about 1,500° C., with a temperature of about 800° C. to about 1,200° C. preferred.

While the negative potential source used to generate the electrical field can be located any distance away from the sensor element, the negative potential source is preferably located at a distance sufficient to allow for ease in sodium ion migration in the sensor element and to allow for a reasonable magnitude of negative potential for use in a manufacturing process. For example, the negative potential source, can be located less than or equal to 6 feet (about 1.8 meters) away from the sensor element, with less than or equal to 3 feet (about 0.9 meters) preferred, and less than or equal to 1 foot (about 0.3 meters) more preferred. In other words, the negative potential can be in direct physical communication with surface of the sensor element.

As briefly noted above, the length of time that the electrical field is applied to the sensor element can influence the magnitude of the negative potential used to generate the electrical field. The time can be sufficient to obtain the desired sodium ion migration to the surface, while being compatible with manufacturing specifications for processing times. All else being equal, the greater the magnitude of the electrical field, the shorter the time for sodium ion migration. In various embodiments, the electrical potential can be applied for a period of time that allows a peak current (e.g., a direct current) in the circuit of the applied electrical field to drop greater than or equal to 75% of the peak current (e.g., if the peak current is 100 milliamperes, the electrical field is applied for a period of time sufficient for the current to drop to 25 milliamperes), with a drop of greater than or equal to 90% preferred. Without being bound by theory, it is noted that the drop in current is related to the migration of sodium ions. More particularly, the current drops as the sodium ions collect at the surface of the sensor element.

In an embodiment, a plate can be disposed in physical communication with a surface of a heater side 44 of the sensor element 10. Sensing electrode 12 and reference electrode 14 are shorted together. A positive lead of a power source (not shown) is disposed in electrical communication with the shorted electrodes 12/14. A negative lead of the power supply is disposed in electrical communication with the plate. In this example, the sodium ions are drawn toward the plate since it generates a negative electrical field, thereby drawing the sodium ions to the surface of the sensor element. It is noted that the plate comprises a conductive material, e.g., a metal.

In other embodiments, two plates can be employed, wherein a first plate is disposed in physical communication with a surface of a heater side 44 of the sensor element 10 and a second plate is disposed in physical communication with a surface of a sensor side 42 of the sensor element 10. The first plate is in electrical communication with a positive lead of a power source and the second plate is in electrical communication with a negative lead of the power source. As described above, the sodium ions are drawn to the surface of the heater side 44 of the sensor element 10 in physical communication with the second plate. However, as noted above, other embodiments are envisioned where the plate(s) is not in physical communication with the sensor element 10.

In various other embodiments, the electrical field can be applied when a power source is applied to the heater 28. As noted above, the heater can be used to heat the sensor element 10 to the operating temperature of sensor element 10, which can increase the mobility of sodium ions. In this example, sodium ions are generally drawn to a negative lead of the heater 28 and/or ground plane (not shown). It is noted that when a ground plane is employed, the ground plane is located between a layer comprising heater 28 and a layer comprising an electrode (e.g., 14). The sodium ions can be drawn away from the negative lead of the heater 28 and/or the ground plane by applying a sufficient electrical field to a surface of the senor element 10 as described above.

In other words, the sodium ions can be step-wise drawn out of the sensor element 10. More particularly, a negative potential can first be applied to the negative lead of the heater 28 and/or ground plane to draw the sodium ions to the negative lead and/or ground plane. A negative potential of greater magnitude than that of negative potential applied to the negative lead of the heater 28 and/or ground plane is applied to a surface on the heater side 44 of the sensor element 10 as described above. As such, the sodium ions are drawn toward the electrical field on the heater side 44 of the sensor element such that the sodium ions collect on the surface of the sensor element 10.

In other embodiments, a sacrificial ground plane 34 is positioned adjacent to or optionally disposed on a surface of insulating layer 32 opposite the surface of insulating layer 32 in physical communication with heater 28. It is noted that sacrificial ground plane 34 can be employed in addition, or alternative, to a ground plane disposed between the heater 28 and electrolyte 16; not shown). Moreover, it is noted that the placement of the sacrificial ground plane 34 is a clear departure from the use of a ground plane as described above. As with the use of a negatively powered plate in physical communication with a surface of the sensor element 10, this embodiment draws sodium ions to surface of the sensor element 10, rather than heater 28 when a negative potential is applied to sacrificial ground plane 34. Additionally, or alternatively, an external electrical field can be applied via a negatively powered plate as discussed above to augment sodium ion migration to the surface of the sensor element 10. However, it is noted that the sacrificial ground plane 34 can be consumed during operation. More particularly, the sacrificial ground plane 34 can be oxidized by the exhaust gas and carried off with the exhaust gas.

Having drawn sodium ions to the surface of the sensor element as described above, the sodium ions can be readily removed from the surface. For example, the sodium ions can be removed by rinsing the surfaces of the sensor element with water. Moreover, it is noted that in addition, or alternative, to rinsing the surface with water, the sodium can be removed as part of post sintering treatment process, wherein the sensor element is treated with a basic or acidic agent.

As briefly mentioned above, the various methods of drawing sodium ions to a surface of a sensing element are equally applicable to other ceramic devices. For example, a ceramic device can comprise a heater disposed on a substrate layer (e.g., heater 28 and insulating layer 32). The sodium ions can be drawn to the surface of the ceramic device, preferably the surface opposite the surface in physical communication with the heater, by any of the methods described above. For example, the heater can be in electrical communication with a first power source, wherein a positive lead of the heater is in electrical communication with a positive lead of the power source and a negative lead of the heater is in electrical communication with a negative lead of the power source. A second power source having a greater electrical potential than the first power source is also employed, wherein a positive lead of the second power supply is disposed in electrical communication with the negative lead of the heater and the negative lead of the second power supply is disposed in electrical communication with a conductive plate disposed in physical communication with a surface of the ceramic device opposite the surface in physical communication with the heater. The electrical field generated by the conductive plate draws the sodium ions to the surface of the ceramic device.

### EXAMPLE

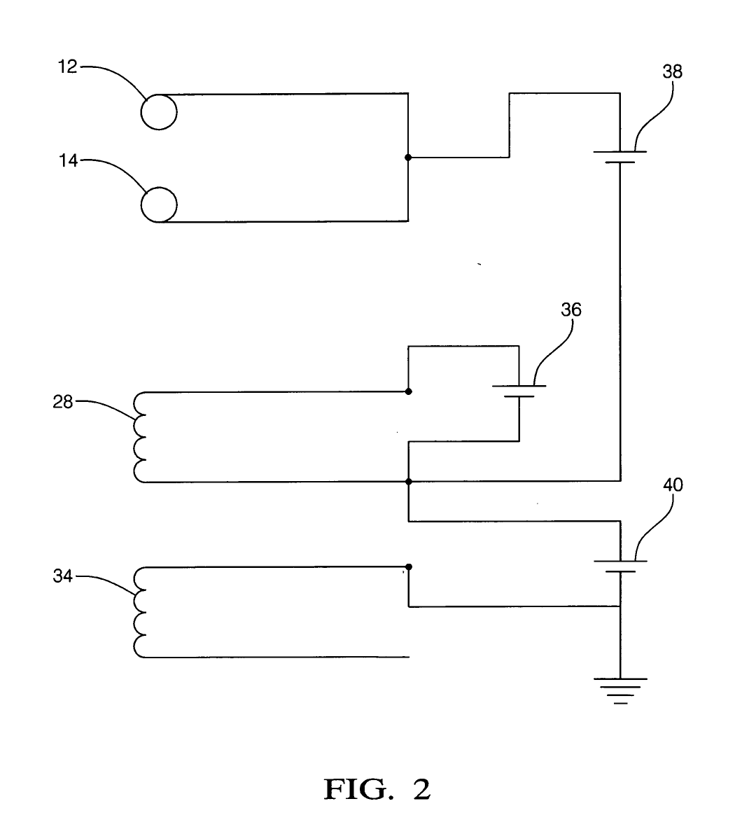

As an example, the following procedure can be used to extract sodium ions from a sensor element, wherein an externally applied ground plane (e.g., sacrificial ground plane 34 illustrated in FIG. 1) is employed. The electrical configuration described below to step-wise draw sodium ions to a surface of the sensor element is schematically illustrated in FIG. 2.

The heater 28 is powered by a first power supply 36 to a voltage sufficient to heat the sensor element to a temperature favorable for sodium ion extraction, e.g., a voltage of about 17.5 volts (V). A second power supply of 50 V is employed, wherein the inner and outer sensor electrodes are shorted together and are disposed in electrical communication with the positive output of the second power supply 38 and the negative lead of the heater is in electrical communication with the negative output of the second power supply 38. A third power supply 40 is employed such that the negative lead of the heater is in electrical communication with the positive output of the third power supply 40 and the sacrificial ground plane 34 is in electrical communication with the negative output of the third power supply 40. This configuration applies a potential of about 150V from the sensor electrodes 12/14 to the sacrificial ground plane 34 with the sensor electrodes 12 at a positive potential and the sacrificial ground plane at a negative potential. This results in driving the sodium within the sensor structure to the sacrificial ground plane 34 where they can later be removed by appropriate washing, e.g., rinsing with water. For this configuration, the voltage is applied until the current in the circuit using the third power supply drops 90% of its initial value, e.g., about 2.5 minutes.

Advantageously, the method(s) of applying an electrical field to a sensor element allows for sodium ions to be drawn to the surface and readily removed from the sensor. This reduction in the sodium concentration can extend the useful life of the sensor by reducing sodium build-up on the ground plane and/or heater, which can cause cross-talk between the ground plane or heater and an electrode, can cause delamitation of the sensor element, and can cause cracking of the sensor. For example, accelerated temperature testing of untreated sensors without ground planes can show significant sodium migration within 24 hours of testing. Sensors, which have used the electrical treatment to extract sodium, have shown minimal sodium migration after 72 hours of testing. Furthermore, these methods offer the advantage of being compatible with various sensor element manufacturing methods, e.g., chemical treatment.

Furthermore, this method is advantageously applicable for use in other ceramic devices where sodium ion migration can be problematic. For example, this method can be used in ceramic devices such as a ceramic heater comprising a resistive element disposed on a ceramic substrate. It is noted that sodium ions in the ceramic substrate (e.g., an alumina substrate) are generally drawn to the negative lead of the resistive element, which can eventually cause the ceramic heater to fail. By employing the disclosed method, sodium ions can be removed from the ceramic heater, thereby extending the life of the ceramic heater.

Additionally, it is noted that the methods disclosed herein allow for substrate material(s) comprising relatively high sodium (e.g., greater than or equal to 2,000 ppm by weight) ion concentrations to be employed, since the sodium ions can be removed by the disclosed methods. Since materials having a lower amount of impurities are generally more expensive than materials having a higher amount of impurities, this method allows a sensor to be manufactured using lower cost materials with a higher concentration of impurities.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of making a sensor element, comprising:
forming a sensor element comprising a first electrode and a second electrode disposed in physical communication with an electrolyte; and
applying an electric field of negative potential to a surface of the sensor element sufficient to draw positively charged impurities to the surface of the sensing element.

2. The method of claim 1, further comprising reducing a positively charged impurity concentration by removing the positively charged impurities from the surface of the sensor element.

3. The method of claim 2, wherein the removing the positively charged impurities comprises rinsing the sensor element with water.

4. The method of claim 1, wherein the applying the electrical field of negative potential comprises shorting the first electrode and the second electrode together, disposing the first electrode and the second electrode in electrical communication with a positive lead of a power source, and disposing a negative lead of the power source in electrical communication with a conductive plate disposed in physical communication with the surface of the sensor element, wherein the surface is on a side of the sensor element farthest away from the first electrode and the second electrode.

5. The method of claim 1, wherein the applying the electrical field of negative potential comprises disposing a first conductive plate in physical communication with the surface on a first side of the sensor element, disposing the first conductive plate in electrical communication with a positive lead of a power source, disposing a second conductive plate in physical communication with the surface on a second side of the sensor element, and disposing the second conductive plate in electrical communication with a negative lead of the power source, wherein the first surface side of the sensor element is the side closest to the first electrode and the second electrode.

6. The method of claim 1, wherein the applying the electrical field of negative potential comprises shorting the first electrode and the second electrode together, disposing the first electrode and the second electrode in electrical communication with a positive lead of a power source, disposing a negative lead of the power source to a sacrificial ground plane disposed on the surface on a side of the sensor element farthest away from the first electrode and the second electrode.

7. The method of claim 1, further comprising heating the sensor element to about 600° C. to about 1500° C.

8. The method of claim 1, wherein the applying of the electric field of the negative potential is for a duration sufficient to allow a peak current in a circuit employed to create the electric field of negative potential to drop greater than or equal to 75% of the peak current.

9. The method of claim 8, wherein the drop is greater than or equal to 90% of the peak current.

10. The method of claim 1, wherein the positively charged impurities are sodium ions.

11. The method of claim 10, wherein a sodium ion concentration after removing the sodium ions is less than or equal to 500 ppm.

12. The method of claim 1, wherein the electric field of negative potential is generated by a conductive plate not in physical communication with the surface of the sensor element.

13. A sensor element made according to the method of claim 1, wherein the sensor element comprises a sodium ion concentration of less than or equal to 500 ppm.

14. A sensor comprising a sensor element made according to the method of claim 1, wherein the sensor element comprises a sodium ion concentration of less than or equal to 500 ppm.

15. A method of making a ceramic device, comprising:
forming a ceramic device by disposing a resistive element on a ceramic substrate; and
applying an electric field of negative potential to a surface of the ceramic device sufficient to draw positively charged impurities to the surface of the ceramic device.

16. The method of claim 15, further comprising reducing a positively charged impurity concentration by removing the positively charged impurities from the surface of the ceramic device.

17. The method of claim 15, wherein the removing the positively charged impurities comprises rinsing the ceramic device with water.

18. The method of claim 15, wherein the applying the electrical field of negative potential comprises disposing a first conductive plate in physical communication with the surface on a first side of the ceramic device, disposing the first conductive plate in electrical communication with a positive lead of a power source, disposing a second conductive plate in physical communication with the surface on a second side of the ceramic device, and disposing the second conductive plate in electrical communication with a negative lead of the power source, wherein the first side of the ceramic device is the surface closest to resistive element.

19. The method of claim 15, further comprising heating the ceramic device to about 600° C. to about 1500° C.

20. The method of claim 15, wherein the applying of the electric field of the negative potential is for a duration sufficient to allow a peak current in a circuit employed to create the electric field of negative potential to drop greater than or equal to 75% of the peak current.

21. The method of claim 20, wherein the drop is greater than or equal to 90% of the peak current.

22. The method of claim 15, wherein the positively charged impurities are sodium ions.

23. A ceramic device made according to the method of claim 15, wherein the ceramic device comprises a sodium ion concentration of less than or equal to 500 ppm.
